(19) United States
(12) Patent Application Publication
(10) Pub. No.: US 2026/0187702 A1
(43) Pub. Date: Jul. 2, 2026

(54) ELECTRONIC DEVICE AND METHOD FOR RECOGNIZING HUMAN CHARACTERISTICS AND RECOMMENDING PRODUCTS

(71) Applicant: NEXTPAYMENTS INC., Seoul (KR)

(72) Inventor: Kwang Chol JEE, Anyang-si (KR)

(21) Appl. No.: 19/548,392

(22) Filed: Feb. 24, 2026

Related U.S. Application Data
(63) Continuation of application No. PCT/KR2024/096105, filed on Aug. 29, 2024.

(30) Foreign Application Priority Data
Aug. 29, 2023 (KR) 10-2023-0113820

(51) Int. Cl. G06Q 30/0601; G06T 7/536; G06T 7/60; G06V 40/16

(52) U.S. Cl. CPC G06Q 30/06312; G06T 7/536; G06T 7/60; G06V 40/172; G06V 40/178; G06T 2207/30201

(57) ABSTRACT

Disclosed is an electronic device for recognizing human characteristics and recommending products. The electronic device may include a display; a memory; and a processor. The processor may capture an appearance of a user using a camera sensor in response to an object being detected within a specified distance from the electronic device and/or a user's input being detected on the display; obtain information on a face, height, shoulder skeleton, and hair length of the user by analyzing the captured appearance of the user; determine a gender and age group of the user based on the information on the face, height, shoulder skeleton, and hair length of the user; and determine a list of products suitable for the user and display the list on the display based on purchase amounts and user review scores of other users of a same gender and age group as the user.

### TECHNICAL FIELD

The present document relates to an electronic device including a kiosk, and more particularly, to an electronic device for recognizing human characteristics and recommending products and a method for operating the electronic device.

### BACKGROUND ART

A kiosk is a device that is installed in a public place so that the general public can easily use it, and delivers information to a user through a touch screen or the like, or displays results for items inputted by the user through the touch screen. Such a kiosk provides a Graphical User Interface (GUI) user application through a screen such as a touch screen, and a user can be provided with various information by directly manipulating a GUI screen. For example, there is a payment kiosk that performs payment for an ordered product or orders a product through a touch screen.

However, although various effects can be expected from the kiosk in that it can effectively replace human labor, general kiosks are designed according to the average height of the general public, so there is difficulty in using them by people who are excessively tall, children, disabled people in wheelchairs, the elderly, patients, and the like.

Meanwhile, Korean Patent Application Publication No. 10-2021-0000078 (Patent Document 1) discloses a “personally adjustable kiosk and control method thereof.” In the case of Patent Document 1, there is an advantage that the height and angle of a display of a kiosk can be adjusted in a personalized manner by using information on a user and the surrounding environment where the kiosk is installed, but the mechanism for adjusting the height and angle of the display in a personalized manner is based on environment information and personalized information of the user received from a user terminal, so there is a limitation that it is difficult for a controller to adjust the height and angle of the display in a personalized manner for a user who is not carrying the user terminal or who has difficulty skillfully operating the user terminal even if they are carrying it.

### SUMMARY

### Technical Problem

Therefore, the present invention has been made in view of the above problems, and it is one object of the present invention to provide an electronic device capable of providing a human-sensing user-convenience customized touch display system for a kiosk, wherein the human-sensing user-convenience customized touch display system can automatically adjust a height and angle of a touch display according to a height (eye level), shoulder height, and the like of various users (customers), thereby allowing a user to comfortably view a screen of the touch display and to easily operate the same.

It is another object of the present invention to provide an electronic device which can determine personal information (e.g., gender and age group) of a user and provide a list of recommended products based on the personal information of the user.

### Technical Solution

In accordance with an aspect of the present invention, the above and other objects can be accomplished by the provision of an electronic device for recognizing human characteristics and recommending products. The electronic device may include a display; a memory; and a processor. The processor may capture an appearance of a user using a camera sensor in response to an object being detected within a specified distance from the electronic device and/or a user's input being detected on the display; obtain information on a face, height, shoulder skeleton, and hair length of the user by analyzing the captured appearance of the user; determine a gender and age group of the user based on the information on the face, height, shoulder skeleton, and hair length of the user; and determine a list of products suitable for the user and display the list on the display based on purchase amounts and user review scores of other users of a same gender and age group as the user.

### Advantageous Effects

An electronic device according to the present document can provide a human-sensing user-convenience customized touch display system for a kiosk, wherein the human-sensing user-convenience customized touch display system can automatically adjust a height and angle of a touch display according to a height (eye level), shoulder height, and the like of various users (customers), thereby allowing a user to comfortably view a screen of the touch display and to easily operate the same.

The electronic device according to the present document can determine personal information (e.g., gender and age group) of a user and provide a list of recommended products based on the personal information of the user.

### BRIEF DESCRIPTION OF DRAWINGS

FIG. 1 is a block diagram illustrating a configuration of an electronic device for recognizing human characteristics and recommending products according to an embodiment.

FIG. 2A illustrates an appearance of an electronic device according to an embodiment. FIG. 2B illustrates a front view of the electronic device according to an embodiment. FIG. 2C illustrates a side view of the electronic device according to an embodiment. FIG. 2D illustrates an isometric view of the electronic device according to an embodiment.

FIG. 3A illustrates an embodiment of recognizing a face of a user on a camera sensor of the electronic device according to an embodiment.

FIG. 3B illustrates an embodiment in which the electronic device according to an embodiment recognizes a face of a user and recommends a product based on a user's age and gender.

FIG. 4 illustrates a process of recognizing a face of a user and displaying user information on the camera sensor of the electronic device according to an embodiment.

FIG. 5 is a flowchart illustrating a method of recognizing human characteristics and recommending products by the electronic device according to an embodiment.

### DETAILED DESCRIPTIONS OF EXEMPLARY EMBODIMENTS

Embodiments may be implemented as a product in a kiosk form. However, this is only an example, and products to which operations of the present document are applied are not limited thereto.

An Artificial Intelligence (AI) system is a computer system that implements human-level intelligence, and unlike a conventional rule-based smart system, it is a system in which a machine learns and judges by itself. As AI systems improve their recognition rate and more accurately understand customer preferences as they are used, conventional rule-based smart systems are being replaced by deep learning-based AI systems.

AI technology consists of machine learning and elementary technologies utilizing machine learning. Machine learning is an algorithm technology for self-classifying/learning characteristics of input data, and elementary technology is a technology for imitating functions such as cognition and judgment of a human brain by utilizing machine learning algorithms such as deep learning, and consists of technical fields such as linguistic understanding, visual understanding, inference/prediction, knowledge representation, and motion control.

Various fields to which AI technology is applied are as follows. Linguistic understanding is a technology for recognizing and applying/processing human language/characters, and includes natural language processing, machine translation, dialogue systems, query answering, speech recognition/synthesis, and the like. Visual understanding is a technology for recognizing and processing an object like human vision, and includes object recognition, object tracking, image search, person recognition, scene understanding, space understanding, image improvement, and the like. Inference prediction is a technology for logically inferring and predicting by judging information, and includes knowledge/probability-based inference, optimization prediction, preference-based planning, recommendation, and the like. Knowledge representation is a technology for automatically processing human experience information into knowledge data, and includes knowledge construction (data generation/classification), knowledge management (data utilization), and the like. Motion control is a technology for controlling autonomous driving of a vehicle and movement of a robot, and includes movement control (navigation, collision, driving), manipulation control (behavior control), and the like.

Machine learning may refer to a process of training a neural network model using experience in processing data. Through machine learning, computer software may mean improving data processing ability by itself. A neural network model is constructed by modeling correlations between data, and the correlations may be expressed by a plurality of parameters. A neural network model extracts and analyzes features from given data to derive correlations between data, and a process of repeating these procedures to optimize parameters of the neural network model may be referred to as machine learning. For example, a neural network model may learn a mapping (correlation) between an input and an output for data given as an input-output pair. Alternatively, even when only input data is given, a neural network model may derive regularity between the given data to learn the relationship.

An AI learning model or a neural network model may be designed to implement a human brain structure on a computer, and may include a plurality of network nodes having weights while simulating neurons of a human neural network. The plurality of network nodes may have connection relationships with each other by simulating synaptic activities of neurons in which neurons exchange signals through synapses. In the AI learning model, the plurality of network nodes may be located in layers of different depths and exchange data according to a convolution connection relationship. The AI learning model may be, for example, an artificial neural network model, a Convolutional Neural Network (CNN), or the like. As an embodiment, the AI learning model may be machine-learned according to a method such as supervised learning, unsupervised learning, or reinforcement learning. For a machine learning algorithm for performing machine learning, a decision tree, a Bayesian network, a support vector machine, an artificial neural network, Ada-boost, a perceptron, genetic programming, clustering, or the like may be used.

Among these, the CNN is a type of multilayer perceptrons designed to use minimal preprocessing. The CNN consists of one or several convolution layers and general artificial neural network layers placed thereon, and additionally utilizes weights and pooling layers. Due to such a structure, the CNN may fully utilize input data of a two-dimensional structure. Compared to other deep learning structures, the CNN shows good performance in both video and audio fields. The CNN may also be trained through standard backpropagation. The CNN tends to be trained more easily than other feedforward artificial neural network techniques and has an advantage of using a small number of parameters.

Convolutional networks are neural networks including sets of nodes having tied parameters. An increase in a size of available training data and availability of computing capability are combined with algorithm developments such as piecewise linear units and dropout training, so that many computer vision tasks have been significantly improved. In huge data sets such as data sets available for many tasks today, overfitting is not significant, and increasing a size of a network improves test accuracy.

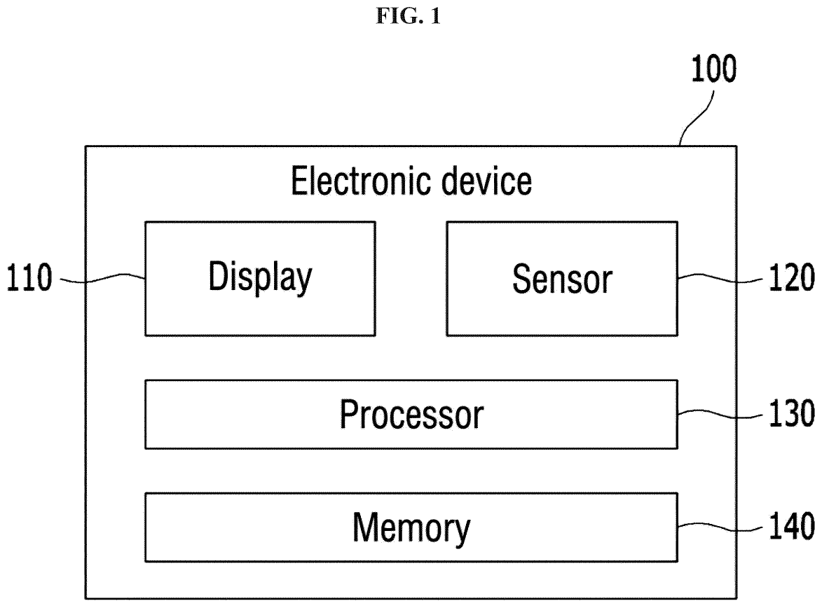

FIG. 1 is a block diagram illustrating a configuration of an electronic device for recognizing human characteristics and recommending products according to an embodiment.

As shown in FIG. 1, an electronic device 100 may include a display 110, a sensor 120, a processor 130, and a memory 140, and some of the illustrated components may be omitted or replaced. The electronic device 100 may include, for example, a kiosk.

According to an embodiment, a size and shape of the display 110 may vary according to a design of the electronic device 100 and a purpose of use thereof. The display 110 may include a built-in touch function to receive a command in response to a touch or a swipe on a screen by a user's finger. A resolution of the display 110 may determine sharpness and quality of contents displayed on the screen. A high-resolution display may display text, images, and video contents more clearly, thereby improving user experience. The display 110 may further include a durable protective layer (e.g., tempered glass) for protection from daily use and an external environment. The protective layer may prevent water droplets, fingerprints, dust, and the like from adhering to the screen, and may extend a lifespan of the display 110.

According to an embodiment, the sensor 120 may include a fingerprint sensor and a camera sensor. The fingerprint sensor may be used to recognize a fingerprint of a user to verify whether the user is a user registered on a database (DB). The camera sensor may be used to recognize a face, height, shoulder skeleton, hair length, and the like of the user. The electronic device 100 may obtain information related to an appearance of the user (e.g., face, height, shoulder skeleton, hair length) using the camera sensor, and may determine personal information (e.g., age group, gender, height) for the user based thereon.

According to an embodiment, the processor 130 is a component capable of performing computation or data processing related to control and/or communication of each component of the electronic device 100, and may be composed of one or more processors. The memory 140 may store information related to the above-described method or store a program in which the above-described method is implemented. The memory 140 may be a volatile memory or a non-volatile memory. The memory 140 may store various file data, and the stored file data may be updated according to operations of the processor 130.

According to an embodiment, the processor 130 may execute a program and control the electronic device 100. A code of the program executed by the processor 130 may be stored in the memory 140. Operations of the processor 130 may be performed by loading instructions stored in the memory 140. The electronic device 100 may be connected to an external device (e.g., a personal computer or a network) through an input/output device (not shown in drawings), and may exchange data.

According to an embodiment, there is no limitation on computation and data processing functions that the processor 130 may implement on the electronic device 100, but hereinafter, a method of determining personal information (e.g., height, gender, age group, etc.) of a user using the electronic device 100 and recommending products will be described.

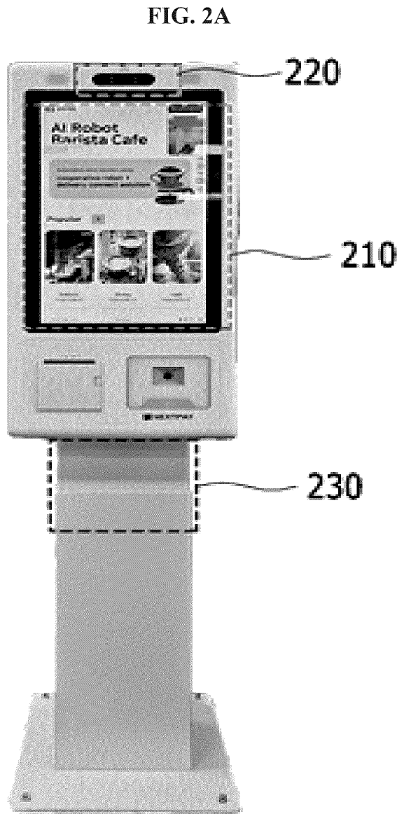

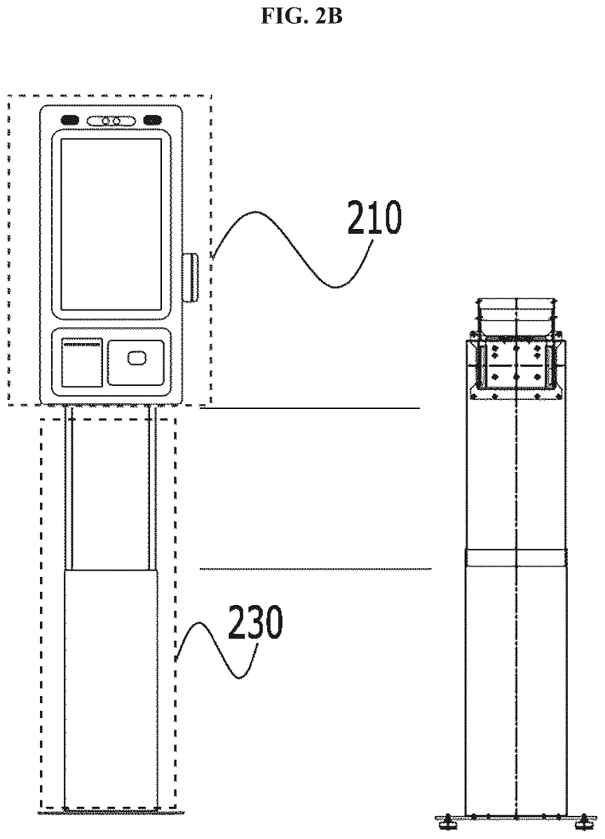

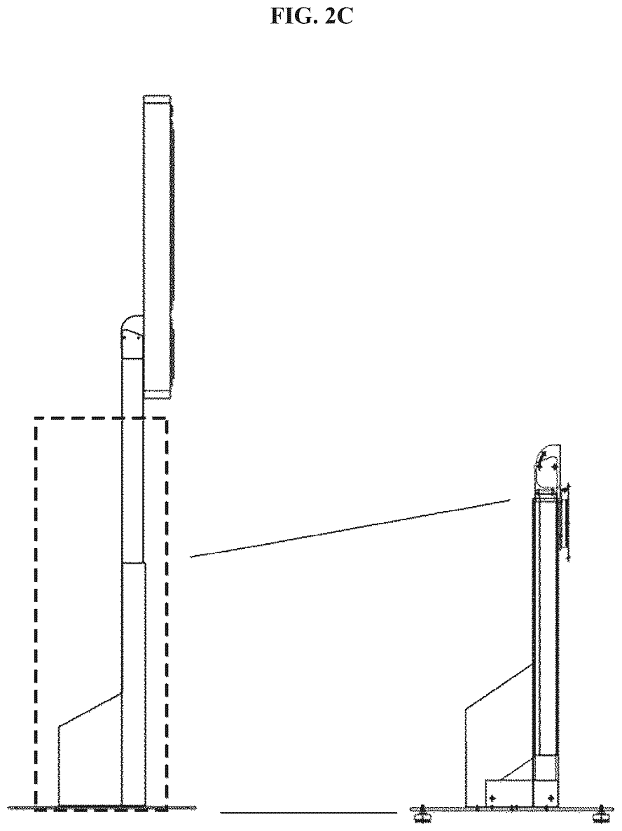

FIG. 2A illustrates an appearance of an electronic device according to an embodiment. FIG. 2B illustrates a front view of the electronic device according to an embodiment. FIG. 2D illustrates a side view of the electronic device according to an embodiment. FIG. 2D illustrates an isometric view of the electronic device according to an embodiment.

The electronic device (e.g., the electronic device 100 of FIG. 1) may include, for example, a kiosk. The electronic device 100 may further include a display 210, a camera sensor 220, and a drive part 230 for adjusting a position of the display 210.

The electronic device 100 may determine types and quantities of menus selected by a user based on a user's input on the display 210 and transmit information onto a server. A server administrator may check order details of the user using the received information and provide services according to the order details.

The electronic device 100 may capture an appearance of the user using the camera sensor 220 and determine personal information (e.g., gender, age group, height) of the user. The electronic device 100 may continuously operate the camera sensor 220 to detect movements of users, or may initiate operation of the camera sensor 220 in response to a user's input being detected on the display 210.

The electronic device 100 may adjust a position of the display 210 up and down using the drive part 230 based on user information (e.g., height).

According to an embodiment, a processor (e.g., the processor 130 of FIG. 1) may capture an appearance of a user using the camera sensor 220 in response to a user's input being detected on the display 210. The processor may analyze the captured appearance of the user to obtain information on a face, height, shoulder skeleton, and hair length of the user, determine a gender and age group of the user based on the information on the face, height, shoulder skeleton, and hair length of the user, and determine a list of products suitable for the user and display it on the display 210 based on purchase amounts and user review scores of other users of the same gender and age group as the user.

According to an embodiment, the processor 130 may recognize a face of the user or one part of the face using the camera sensor 220, may determine a height of the user based on the recognized body part of the user, and may adjust a position of the display 210 of the electronic device 100 up and down in response to the determined height of the user.

The electronic device 100 may further include a distance measurement sensor in addition to the camera sensor 220. The electronic device 100 may start capturing or recognition, using the camera sensor 220, for a user who has approached within a specified level from the electronic device by using the distance measurement sensor composed of an ultrasonic sensor or a depth sensor. Alternatively, the electronic device 100 may start capturing or recognition using the camera sensor 220 in response to a user's input being detected on the display 210.

The electronic device 100 may adjust a length of the drive part 230 up and down based on a body part of the user recognized through the camera sensor 220. The electronic device 100 may adjust a position of the display 210 of the electronic device 100 up and down using the drive part 230.

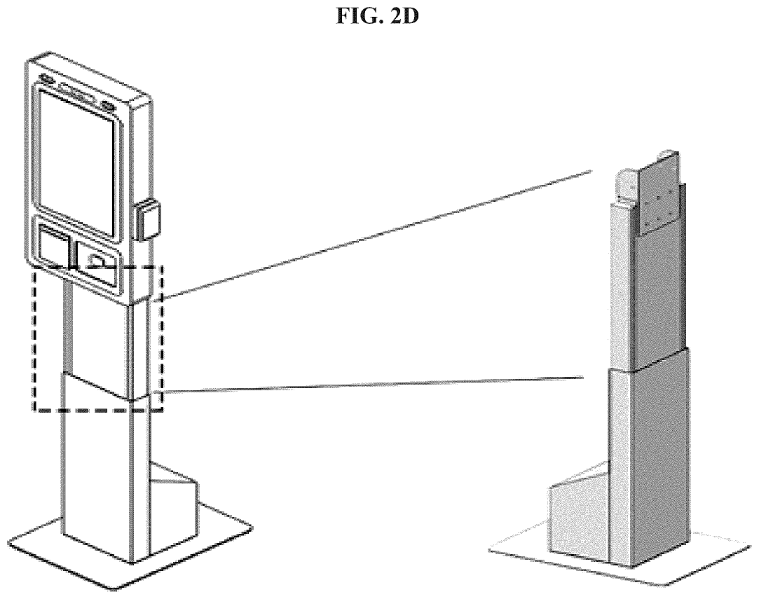

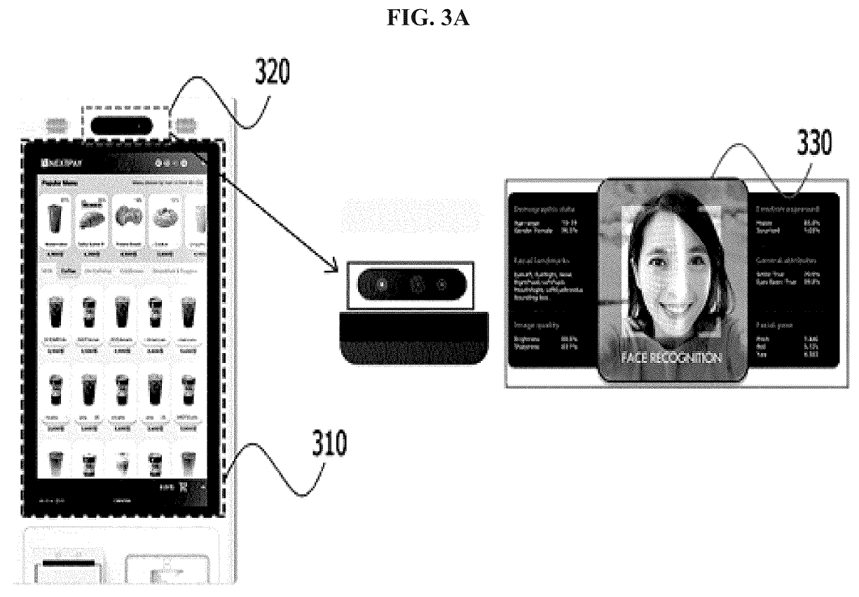

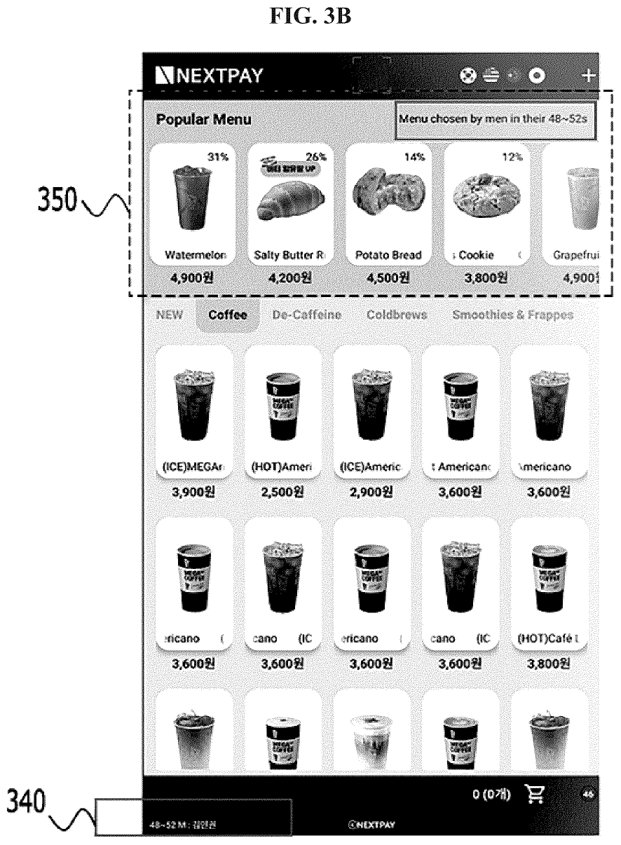

FIG. 3A illustrates an embodiment of recognizing a face of a user on the camera sensor of the electronic device according to an embodiment.

In FIG. 3a, an electronic device (e.g., the electronic device 100 of FIG. 1) may include a display 310 and a camera sensor 320. The electronic device 100 may recognize a face and body parts of the user using the camera sensor 320.

Drawing 330 of FIG. 3A illustrates a situation of recognizing the user's face and inferring personal information (e.g., gender, age group, height) of the user based on the recognized information.

According to an embodiment, a processor (e.g., the processor 130 of FIG. 1) may determine an age group of a user based on information on a face, height, shoulder skeleton, and hair length of the user, receive product purchase records of other users having the same age group as the determined age group of the user, display recommended products in a descending order of cumulative purchase amounts of the other users for a specified period (e.g., 3 months), and display a product, whose current sales amount has increased by more than a specified level (e.g., 50%) compared to a sales amount before the specified period (e.g., 3 months), as a rising popularity product.

The processor 130 may receive product purchase records of other users having the same age group from an external server. The external server may include information on kiosks of other companies that sell the same type of products as those of the electronic device 100. For example, in a case where the electronic device 100 is used in a cafe in the food and beverage industry, the external server may obtain information on user orders from a plurality of kiosks used in other cafes.

In a case where the processor 130 recognizes a user as a male in a 30s age group using the camera sensor 320, the processor 130 may receive cafe order records corresponding to males in the 30s age group from an external server. The electronic device 100 may determine a list of products to be recommended to males in the 30s age group based on the received information, and display the list on the display 310. A cafe, 30s, and a male are only examples, and an industry, and a gender and age group of a user may vary according to settings. In a case where kiosks are of the same franchise company, the external server may determine to provide information on the same industry.

The processor 130 may display recommended products in a descending order of cumulative purchase amounts of other users for a specified period (e.g., 3 months). Here, the other users may include not only users recorded on the electronic device 100, but also records of other kiosks whose industry, gender, and age group match. The specified period (e.g., 3 months) is only an example and may vary according to settings.

The processor 130 may display recommended products in a descending order of cumulative purchase amounts of other users for a specified period (e.g., 3 months) based on the present, and may display a product, whose cumulative purchase amount during the specified period based on the present has increased by exceeding a first level (e.g., 50%) compared to a cumulative purchase amount during a specific past period, as a rising popularity product.

The cumulative purchase amount of other users during the specified period based on the present may mean, for example, a cumulative purchase amount for the past 3 months based on a current time point, or may mean a cumulative purchase amount for the past 1 month based on the current time point. The cumulative purchase amount during the specific past period may mean, for example, a cumulative purchase amount up to 6 months ago based on a time point 3 months ago, or may mean a cumulative purchase amount up to 4 months ago based on the time point 3 months ago. A current sales amount serving as a reference and a previous sales amount serving as a comparison target may vary according to period settings. The specified period (e.g., 3 months) and the specified level (e.g., 50%) are only examples and may vary according to settings.

FIG. 3B illustrates an embodiment in which the electronic device according to an embodiment recognizes a face of a user and recommends a product based on a user's age and gender.

In FIG. 3B, the processor 130 may recognize and display an age and a gender of the user as illustrated in Drawing 340. The processor 130 may recommend products having highest sales amounts in a corresponding age group and gender based on the age and the gender of the user as illustrated in Drawing 350.

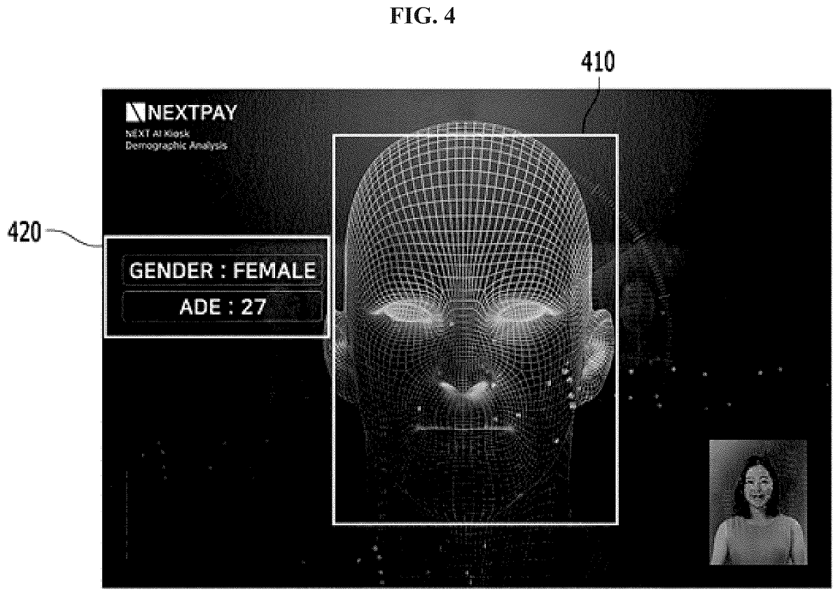

FIG. 4 illustrates a process of recognizing a face of a user and displaying user information on the camera sensor of the electronic device according to an embodiment.

In FIG. 4, the electronic device (e.g., the electronic device 100 of FIG. 1) may recognize a face and body parts (e.g., upper body, shoulders) of the user using the camera sensor (e.g., the camera sensor 220 of FIG. 2). Alternatively, the electronic device 100 may determine information on the number of people and a floating population located within a specified zone by sharing information among a plurality of kiosks.

In FIG. 4, the electronic device 100 may recognize a face 410 and body parts of the user using the camera sensor 220. The camera may include, for example, a vision camera or a thermal infrared camera. The electronic device 100 may detect not only a user who is inputting an order but also other users passing by behind. The electronic device 100 may distinguish whether a person is a user currently inputting an order onto the electronic device 100 or a passerby based on a distance from the user. Alternatively, the electronic device 100 may distinguish whether a person is a user currently inputting an order onto the electronic device 100 or a passerby based on a body size. The processor 130 may detect a plurality of users using a vision camera or a thermal infrared camera, measure distances between the electronic device and the plurality of users based on a sensor, and determine whether a person is a user inputting an order onto the electronic device or a passerby based on the measured distances.

Alternatively, the processor 130 may determine that a person is a passerby rather than a user inputting an order based on the recognized body size of the user being less than a specified level. In a case where a user makes an order on a kiosk, the user may approach within a specified distance for a user's input. When the user approaches within a specified distance based on the kiosk, the body size of the user may be measured to be at least a certain level or more. On the other hand, in a case of a person passing by from a distance, a body size of the person may be measured by a camera on the kiosk, but may be measured relatively small due to a long distance. In a case where the body size is measured to be smaller than a specific level, the processor 130 may determine that the person is a passerby without measuring a distance from the user.

Drawing 420 of FIG. 4 illustrates a situation in which the electronic device 100 infers and displays personal information of a user using the camera sensor 220. For example, the electronic device 100 may determine that a gender of the user is female and an age is 27 years old, and display the same on a display (e.g., the display 110 of FIG. 1).

The electronic device 100 may receive capturing information measured by camera sensors included in a plurality of kiosks using a communication circuit. The camera sensors included in the plurality of kiosks may be used to determine the number of people located in a specific zone or the number of a floating population passing by.

According to an embodiment, the processor (e.g., the processor 130 of FIG. 1) may receive user data, related to product sales, from other kiosks having matching industry information and franchise information, and determine a most sold product for each gender and age group based on the received user data. The processor 130 may assign a specified score (e.g., 3 points) to a product sold most in one kiosk, assign a relatively low score (e.g., 1 point) to a product sold second most in one kiosk, and assign scores to the most sold product and the second most sold product for each kiosk and calculate an integrated score. The specified score (e.g., 3 points) is only an example and may vary according to settings. However, a relatively higher score may be assigned to the most sold product than to the second most sold product.

The processor 130 may determine a product having the highest integrated score as a regional best recommended product, and transmit an advertisement and discount coupon of the regional best recommended product onto all user terminals recorded in databases of kiosks located in a corresponding region. Here, the region may refer to points within a specified distance (e.g., a radius of 5 km) based on a point where the electronic device 100 is located. The specified distance (e.g., a radius of 5 km) is only an example and may vary according to settings.

The processor 130 may classify kiosks within the specified distance (e.g., a radius of 5 km), based on the point where the electronic device 100 is located, as kiosks within the same region.

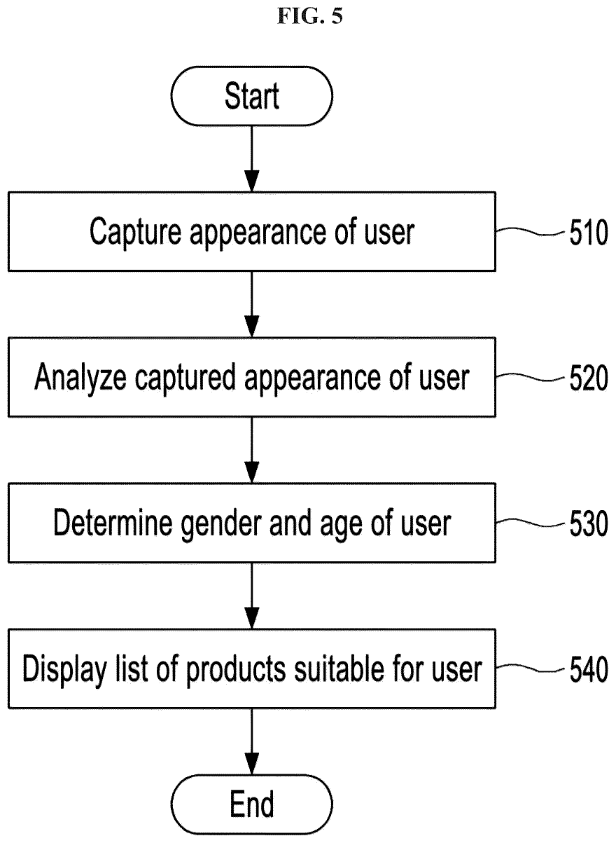

FIG. 5 is a flowchart illustrating a method of recognizing human characteristics and recommending products by the electronic device according to an embodiment.

In operation 510, a processor (e.g., the processor 130 of FIG. 1) may capture an appearance of a user. The processor 130 may capture the appearance of the user using a camera sensor (e.g., the camera sensor 220 of FIG. 2) in response to an object being detected within a specified distance from an electronic device (e.g., the electronic device 100 of FIG. 1) and/or a user's input being detected on a display (e.g., the display 210 of FIG. 2).

In operation 520, the processor 130 may analyze the captured appearance of the user. The processor 130 may analyze the captured appearance of the user to obtain information on a face, height, shoulder skeleton, and hair length of the user.

In operation 530, the processor 130 may determine a gender and age group of the user. The processor 130 may determine the gender and age group of the user based on the information on the face, height, shoulder skeleton, and hair length of the user.

In operation 540, the processor 130 may display a list of products suitable for the user. The processor 130 may determine the list of products suitable for the user, based on purchase amounts and user review scores of other users of the same gender and age group as the user, and display the same on the display 210.

According to an embodiment, the processor 130 may store types and quantities of products, purchased by the user, in a memory (e.g., the memory 140 of FIG. 1) based on a user's input on the display 210, and determine that a product is a popular product in the gender and age group of the user based on a sales amount exceeding a specified count for a specific period (e.g., 1 month) based on the present among the products purchased by the user.

The processor 130 may determine that a product corresponding to a keyword is a currently trendy product when, as a result of a search for the keyword on a specific portal site, a total number of posts for the keyword exceeds a first level (e.g., 10,000) and a number of posts for the keyword uploaded during a recent week exceeds 50% (e.g., 5,000) of the first level.

The processor 130 may transmit an advertisement and discount coupon for a corresponding product to terminals of other users matching the gender and age group of the user based on determining that the product is a popular product in the gender and age group of the user, and provide a guide recommending increasing search advertisements on a specific portal site based on determining that the product is a currently trendy product. The electronic device 100 may receive an input of contact information of a user terminal for point accumulation, coupon issuance, and the like at the time of ordering, and transmit the advertisement and discount coupon of a first product based on the contact information.

According to an embodiment, the processor 130 may store types and quantities of products, purchased by the user, in the memory 140 based on a user's input on the display 210, and determine a first product, whose current sales amount has increased by exceeding a specified level (e.g., 100%) compared to a sales amount before a specified period (e.g., 1 month), as a popular product in the gender and age group of the user. Here, the specified period and the current sales amount level are only examples and may vary according to settings.

The processor 130 may determine that the first product is a popular product in all genders and age groups based on the current sales amount of the first product increasing by exceeding a specified level (e.g., 100%) compared to a sales amount before a specified period (e.g., 1 month) even among users of genders and age groups different from the gender and age group of the user, and transmit an advertisement and discount coupon for the first product onto all user terminals recorded in a database of the electronic device 100. The electronic device 100 may receive an input of contact information of a user terminal for point accumulation, coupon issuance, and the like at the time of ordering, and transmit the advertisement and the discount coupon of the first product based on the contact information. Here, the specified period (e.g., 1 month) and the specified level (e.g., 100%) are only examples and may vary according to settings. For example, the processor 130 may determine that the first product is a popular product in all genders and age groups according to settings even in a situation where the current sales amount of the first product has increased by 50% compared to a sales amount of 3 months ago.

According to an embodiment, the processor 130 may determine a height of a user based on at least one body part of the user recognized using the camera sensor 220, and determine that the user is female based on the determined height of the user being less than a specified level (e.g., 165 cm) and a width of a shoulder skeleton of the user being less than a specified level (e.g., 45 cm). Here, the height of the user and the width of the shoulder skeleton thereof are only examples and are not limited thereto, and may vary according to settings.

The processor 130 may determine that the user is male based on the determined height of the user exceeding (or being equal to or more than) a specified level (e.g., 180 cm) and the width of the shoulder skeleton of the user exceeding a specified level (e.g., 70 cm).

The processor 130 may increase a probability that the user is female by 10% based on a hair length of the user exceeding a specified level (e.g., 10 cm below an ear), and decrease the probability that the user is female by 10% based on the hair length of the user being less than a specified level (e.g., 3 cm below the ear).

The processor 130 may decrease the probability that the user is female by 10% based on a face size of the user exceeding a specified level (e.g., 25 cm vertically), and increase the probability that the user is female by 10% based on the face size of the user being less than a specified level (e.g., 20 cm vertically).

The processor 130 may increase the probability that the user is female by 10% based on the height of the user being less than a specified level (e.g., 160 cm), and may decrease the probability that the user is female by 10% based on the height of the user exceeding a specified level (e.g., 175 cm).

The processor 130 may decrease the probability that the user is female by 10% based on the width of the shoulder skeleton of the user exceeding a specified level (e.g., 60 cm), and increase the probability that the user is female by 10% based on the width of the shoulder skeleton of the user being less than a specified level (e.g., 50 cm). Here, the height of the user and the width of the shoulder skeleton are only examples and are not limited thereto, and may vary according to settings.

The processor 130 may determine that the user is female based on a sum of all probabilities that the user is female being 50% or more, and determine that the user is male based on the sum of all probabilities that the user is female being less than 50%.

According to an embodiment, the processor 130 may receive first information on product purchase amounts of other users of the same gender and age group as a user for a specified period (e.g., 3 months) from other kiosks connected to an external server. The processor 130 may receive information on product purchase amounts from other kiosks located in a first zone in real time, receive second information organized with respect to a commercial area and product sales amounts by analyzing the information, determine a list of recommended products corresponding to a gender and age group of the user based on the first information and the second information, and display the list of recommended products on the display 210. The specified period (e.g., 3 months) is only an example and may vary according to settings.

The first information may refer to information selected based on information received from all other kiosks linked to an external server without area limitation. Since the first information is received from all kiosks, it may take a relatively long time to process the information, and analysis may be performed by setting a specified period. Since the first information has a large number of samples (e.g., data transmitted from a kiosk), accuracy is relatively high, but freshness may be low because analysis takes time.

The second information may refer to information selected based on information received from other kiosks located in the first zone. Since the second information has fewer target kiosks, analysis may be performed in real time. Since the second information analyzes sales information of nearby kiosks based on a position of the electronic device 100, relevance to a local commercial area is relatively high, and there is an advantage of high freshness.

According to an embodiment, the processor 130 may provide a guide on the number of personnel required for startup based on information on a time slot in which orders are most frequently received and information on an order amount, and provide a guide on a recommended industry and a recommended product for startup based on information on types of most sold products and industries in the first zone.

According to an embodiment, the processor 130 may determine a zone within a radius of 5 km of another kiosk as a second zone when the number of people passing by the another kiosk for a specified time (e.g., 10 minutes) exceeds a specified level (e.g., 100 people). The radius of 5 km is only an example, and a range of the second zone may vary according to settings.

The processor 130 may obtain information on gender and age groups of people making orders in the second zone, information on types of products and industries sold most frequently in the second zone, information on a time slot in which orders are most frequently received, and information on an order amount, by using other kiosks located in the second zone.

The processor 130 may select information of a first zone and a second zone based on information on a gender and age group of target customers at the time of starting a business. The processor 130 may compare products and industries sold most in the first zone with products and industries sold most in the second zone, and provide a guide on a recommended industry and a recommended product at the time of starting a business based on a result of the comparison.

According to an embodiment, the processor 130 may recommend selecting a corresponding industry and starting a business based on a kiosk corresponding to an industry having the highest sales amount in the second zone not being present in the first zone.

According to an embodiment, the processor 130 may recommend selecting an industry that has the highest sales amount in the second zone, and starting a business in the industry, based on the number of kiosks corresponding to the industry in the first zone being less than a specified number (e.g., 3). The specified number (e.g., 3) is only an example, and the number of kiosks for recommending starting a business may vary according to settings.

The processor 130 may decide not to recommend starting a business in an industry that has the highest sales amount in the second zone, based on the number of kiosks corresponding to the industry in the first zone exceeding a specified number (e.g., 10).

1. An electronic device for recognizing human characteristics and recommending products, the electronic device comprising:
a display;
a memory; and
a processor,
wherein the processor:
captures an appearance of a user using a camera sensor in response to an object being detected within a predetermined distance from the electronic device and/or a user's input being detected on the display;
obtains information on a face, height, shoulder skeleton, and hair length of the user by analyzing the captured appearance of the user;
determines a gender and age group of the user based on the information on the face, height, shoulder skeleton, and hair length of the user; and
determines a list of products suitable for the user and displays the list on the display based on purchase amounts and user review scores of other users of a same gender and age group as the user.

2. The electronic device according to claim 1, wherein the processor:
recognizes a face of the user or one part of the face using the camera sensor;
determines the height of the user based on the recognized body part of the user; and
adjusts a position of the display of the electronic device up and down in response to the determined height of the user.

3. The electronic device according to claim 1, wherein the processor:
determines the age group of the user based on the information on the face, height, shoulder skeleton, and hair length of the user;
receives product purchase records of other users having a same age group as the determined age group of the user;
displays recommended products in a descending order of cumulative purchase amounts of other users for a first predetermined period based on a current time; and
display a product, for which a cumulative purchase amount of other users during the predetermined period based on the current time has increased by an amount exceeding a first level compared to a cumulative purchase amount of other users during a predetermined past period, as a rising popularity product.

4. The electronic device according to claim 1, wherein the processor:
stores types and quantities of products, purchased by the user, in the memory based on a user's input on the display;
determines, among products purchased by the user, a product for which a sales amount of other users in a same gender and age group as the user exceeds a predetermined count for a second predetermined period from a current time, as a popular product for the gender and age group;
determines that a product corresponding to a keyword is a currently trendy product when, as a result of a search for the keyword on a predetermined portal site, a total number of posts for the keyword exceeds a first level (e.g., 10,000) and the number of posts uploaded during a recent week exceeds 50% of the first level.

5. The electronic device according to claim 4, wherein the processor displays a guide recommending increasing search advertisements on the predetermined portal site based on determining that the product is the currently trendy product.

6. The electronic device according to claim 1, wherein the processor:
stores types and quantities of products, purchased by the user, in the memory based on the user's input on the display;
determines a first product, for which a current sales amount of other users has increased by an amount exceeding a predetermined level compared to a sales amount of other users before a second predetermined period, as a popular product in the gender and age group of the user;
determines that the first product is a popular product in all genders and age groups based on the current sales amount of the first product increasing by an amount exceeding the predetermined level compared to the sales amount before the predetermined period, even among users of genders and age groups different from the gender and age group of the user; and
transmits an advertisement and discount coupon for the first product onto all user terminals recorded in a database of the electronic device.

7. The electronic device according to claim 1, wherein the processor:
determines other kiosks having matching industry information and franchise information based on industry information and franchise information registered in the electronic device;
requests user data inputted on the determined other kiosks or receives user data, inputted on the other kiosks, from a database of an external server;
determines rankings of products sold most within a corresponding franchise by summing all received user data; and
displays a list of franchise popular products based on the determined rankings.

8. The electronic device according to claim 7, wherein the processor:
receives user data, related to product sales, from other kiosks having matching industry information and franchise information;
determines a most sold product for each gender and age group based on the received user data;
assigns a predetermined score to a product sold most in one kiosk;
assigns a relatively low score (e.g., 1 point) to a product sold second most in the kiosk;
assigns scores to the most sold product and the second most sold product for each kiosk and calculates an integrated score;
determines a product having a highest integrated score as a regional best recommended product; and
transmits an advertisement and discount coupon for the regional best recommended product onto all user terminals recorded in databases of kiosks located in a corresponding region.

9. The electronic device according to claim 8, wherein the region refers to points within a predetermined distance based on a point where the electronic device is located, and
the processor classifies kiosks within the predetermined distance, based on the point where the electronic device is located, as kiosks within a same region.

10. The electronic device according to claim 1, further comprising: a vision camera or a thermal infrared camera,
wherein the processor:
detects a plurality of users using the vision camera or the thermal infrared camera;
measures distances between the electronic device and the plurality of users based on a sensor, and determines whether a person is a user currently inputting an order on the electronic device or a passerby based on the measured distances; or
determines that the person is a passerby rather than a user inputting an order, based on a recognized body size of the user being less than a predetermined level.
